(19) United States
(12) Patent Application Publication
(10) Pub. No.: US 2026/0129232 A1
(43) Pub. Date: May 7, 2026

(54) METHOD OF ENCODING/DECODING GAUSSIAN SPLAT FOR 3D SPACE REPRESENTATION

(71) Applicant: Electronics and Telecommunications Research Institute, Daejeon (KR)

(72) Inventors: Gwangsoon LEE, Daejeon (KR); Kwan Jung OH, Daejeon (KR); Jun Young JEONG, Daejeon (KR)

(73) Assignee: Electronics and Telecommunications Research Institute, Daejeon (KR)

(21) Appl. No.: 19/374,776

(22) Filed: Oct. 30, 2025

(30) Foreign Application Priority Data
Nov. 1, 2024 (KR) 10-2024-0153690
Jan. 15, 2025 (KR) 10-2025-0006396
Mar. 25, 2025 (KR) 10-2025-0038351
Apr. 1, 2025 (KR) 10-2025-0042348

(51) Int. Cl. H04N 19/597; H04N 19/136; H04N 19/167; H04N 19/172

(52) U.S. Cl. CPC H04N 19/597; H04N 19/136; H04N 19/167; H04N 19/172

(57) ABSTRACT

According to a method of encoding a Gaussian splat for 3D space representation of the present disclosure, the method comprising generating model parameters of Gaussian splats; generating at least one video frame based on the model parameters; and encoding the at least one video frame, wherein type information indicating a type of a model parameter included in a video frame is encoded as a metadata.

### BACKGROUND OF THE INVENTION

### Field of the Invention

The present disclosure related to a method of encoding/decoding a gaussian splat for 3D space representation.

### Description of the Related Art

3D Gaussian splatting is a technology that models the radiance field of a 3D space as a collection of 3D Gaussians, rendering the 3D space into a 2D image. Each GS (Gaussian Splat) consists of multiple attribute information, and the amount of data per GS is enormous. Consequently, various studies are currently underway to effectively compress the data representing the GS.

### SUMMARY OF THE INVENTION

It is an object of the present disclosure to provide a method for encoding/decoding model parameters of a Gaussian splat into 2D images for 3D space representation.

It is a further object of the present disclosure to provide a method for packing model parameters of a Gaussian splat into a plurality of regions and encoding/decoding metadata for the same.

It is a further object of the present disclosure to provide a method for classifying model parameters of a Gaussian splat into a plurality of levels, packing data for each level into a plurality of regions, and encoding/decoding metadata for the same.

It is a further object of the present disclosure to provide a method for encoding/decoding model parameters of a Gaussian splat based on a codebook and a label.

The technical problems to be achieved by the present disclosure are not limited to the technical problems mentioned above, and other technical problems not mentioned herein may be clearly understood by those skilled in the art from the description below.

In accordance with an aspect of the present disclosure, the above and other objects can be accomplished by the provision of a method of encoding a Gaussian splat for 3D space representation, the method comprising generating model parameters of Gaussian splats; generating at least one video frame based on the model parameters; and encoding the at least one video frame, wherein type information indicating a type of a model parameter included in a video frame is encoded as a metadata.

In the method of encoding a Gaussian splat for 3D space representation according to the present disclosure, each model parameter is packed into a separate video frame, and the type information is encoded for each of video frame.

In the method of encoding a Gaussian splat for 3D space representation according to the present disclosure, each model parameter is packed into a separate video frame, a first video frame comprises a first model parameter, and each of sub-parameters of the first parameter is packed into a separate tile in the first video frame.

In the method of encoding a Gaussian splat for 3D space representation according to the present disclosure, each model parameter is packed into a separate video frame, information for identifying the sub-parameters comprised in the first video frame is encoded.

In the method of encoding a Gaussian splat for 3D space representation according to the present disclosure, each model parameter is packed into a separate video frame, a first frame comprises a first model parameter, and each of sub-parameters of the first model parameter is packed into a separate channel of the first video frame.

In the method of encoding a Gaussian splat for 3D space representation according to the present disclosure, each model parameter is packed into a separate video frame, high-bit data of a first model parameter is packed into a first video frame and low-bit data of the first model parameter is packed into a second video frame.

In the method of encoding a Gaussian splat for 3D space representation according to the present disclosure, each model parameter is packed into a separate video frame, the first model parameter represents position information of the Gaussian splats.

In the method of encoding a Gaussian splat for 3D space representation according to the present disclosure, each model parameter is packed into a separate video frame, a pixel value in the video frame is obtained by performing a non-linear transform on the model parameter.

In the method of encoding a Gaussian splat for 3D space representation according to the present disclosure, each model parameter is packed into a separate video frame, the non-linear transform is performed based on piece-wise linear scaling or a multiple order non-linear function.

In the method of encoding a Gaussian splat for 3D space representation according to the present disclosure, each model parameter is packed into a separate video frame, information on the piece-wise linear scaling or the multiple order non-linear function is encoded as a metadata, and the information comprises at least one of a number of piece intervals or coefficients of the non-linear function.

In the method of encoding a Gaussian splat for 3D space representation according to the present disclosure, each model parameter is packed into a separate video frame, a first model parameter is categorized into a plurality of levels, and each of the plurality of levels is packed into a separate region in a first video frame.

In the method of encoding a Gaussian splat for 3D space representation according to the present disclosure, each model parameter is packed into a separate video frame, a codebook is generated by assigning a code value to each of groups, the groups being obtained by categorizing data of a first model parameter, a first video frame is generated based on a label of attribute values constituting the first model parameter, and the label indicates a code value corresponding to an attribute value.

In the method of encoding a Gaussian splat for 3D space representation according to the present disclosure, each model parameter is packed into a separate video frame, the first mode parameter represents a high-order spherical harmonic function.

In the method of encoding a Gaussian splat for 3D space representation according to the present disclosure, each model parameter is packed into a separate video frame, the codebook is encoded separately with the first video frame as a metadata.

According to method of decoding a Gaussian splat for 3D space representation of the present disclosure, the method comprising decoding at least one video frame; reconstructing model parameters of Gaussian splats from at least one decoded video frame; and rendering an image of target viewpoint based on the model parameters of the Gaussian splats, wherein type information indicating a type of a model parameter included in a video frame is decoded as a metadata.

Meanwhile, in the present disclosure, it is possible to provide a computer-readable recording medium recording instructions for implementing the method of encoding/decoding a Gaussian splat for 3D space representation.

### BRIEF DESCRIPTION OF THE DRAWINGS

FIG. 1 illustrates method of representing a 3D space based on a radiance field and rendering a video.

FIG. 2 is a block diagram illustrating an encoder and a decoder for providing a radiance field-based 3D service according to an embodiment of the present disclosure.

FIG. 3 illustrates an example of model parameters of Gaussian splat being converted into 2D images.

FIG. 4 illustrates an example of non-linear normalization based on piece-wise linear scaling.

FIG. 5 illustrates an example of a video frame structure generated by converting a model parameter.

FIG. 6 illustrates an example in which model parameters or sub-parameters of Gaussian splats are packed into different channels.

FIG. 7 illustrates an example where model parameters at different levels are packed into different tiles.

FIG. 8 is a flowchart of a method for packing a higher-order spherical harmonic function into a video frame.

FIG. 9 illustrates an example of encoding the spherical harmonic function coefficients of a Gaussian splat based on a codebook and a label.

### DETAILED DESCRIPTION OF THE INVENTION

As the present disclosure may make various changes and have multiple embodiments, specific embodiments are illustrated in a drawing and are described in detail in a detailed description. But, it is not to limit the present disclosure to a specific embodiment, and should be understood as including all changes, equivalents and substitutes included in an idea and a technical scope of the present disclosure. A similar reference numeral in a drawing refers to a like or similar function across multiple aspects. A shape and a size, etc. of elements in a drawing may be exaggerated for a clearer description. A detailed description on exemplary embodiments described below refers to an accompanying drawing which shows a specific embodiment as an example. These embodiments are described in detail so that those skilled in the pertinent art can implement an embodiment. It should be understood that a variety of embodiments are different each other, but they do not need to be mutually exclusive. For example, a specific shape, structure and characteristic described herein may be implemented in other embodiment without departing from a scope and a spirit of the present disclosure in connection with an embodiment. In addition, it should be understood that a position or an arrangement of an individual element in each disclosed embodiment may be changed without departing from a scope and a spirit of an embodiment. Accordingly, a detailed description described below is not taken as a limited meaning and a scope of exemplary embodiments, if properly described, are limited only by an accompanying claim along with any scope equivalent to that claimed by those claims.

In the present disclosure, a term such as first, second, etc. may be used to describe a variety of elements, but the elements should not be limited by the terms. The terms are used only to distinguish one element from other element. For example, without getting out of a scope of a right of the present disclosure, a first element may be referred to as a second element and likewise, a second element may be also referred to as a first element. A term of and/or includes a combination of a plurality of relevant described items or any item of a plurality of relevant described items.

When an element in the present disclosure is referred to as being “connected” or “linked” to another element, it should be understood that it may be directly connected or linked to that another element, but there may be another element between them. Meanwhile, when an element is referred to as being “directly connected” or “directly linked” to another element, it should be understood that there is no another element between them.

As construction units shown in an embodiment of the present disclosure are independently shown to represent different characteristic functions, it does not mean that each construction unit is composed in a construction unit of separate hardware or one software. In other words, as each construction unit is included by being enumerated as each construction unit for convenience of a description, at least two construction units of each construction unit may be combined to form one construction unit or one construction unit may be divided into a plurality of construction units to perform a function, and an integrated embodiment and a separate embodiment of each construction unit are also included in a scope of a right of the present disclosure unless they are beyond the essence of the present disclosure.

A term used in the present disclosure is just used to describe a specific embodiment, and is not intended to limit the present disclosure. A singular expression, unless the context clearly indicates otherwise, includes a plural expression. In the present disclosure, it should be understood that a term such as “include” or “have”, etc. is just intended to designate the presence of a feature, a number, a step, an operation, an element, a part or a combination thereof described in the present specification, and it does not exclude in advance a possibility of presence or addition of one or more other features, numbers, steps, operations, elements, parts or their combinations. In other words, a description of “including” a specific configuration in the present disclosure does not exclude a configuration other than a corresponding configuration, and it means that an additional configuration may be included in a scope of a technical idea of the present disclosure or an embodiment of the present disclosure.

Some elements of the present disclosure are not a necessary element which performs an essential function in the present disclosure and may be an optional element for just improving performance. The present disclosure may be implemented by including only a construction unit which is necessary to implement essence of the present disclosure except for an element used just for performance improvement, and a structure including only a necessary element except for an optional element used just for performance improvement is also included in a scope of a right of the present disclosure.

Hereinafter, an embodiment of the present disclosure is described in detail by referring to a drawing. In describing an embodiment of the present specification, when it is determined that a detailed description on a relevant disclosed configuration or function may obscure a gist of the present specification, such a detailed description is omitted, and the same reference numeral is used for the same element in a drawing and an overlapping description on the same element is omitted.

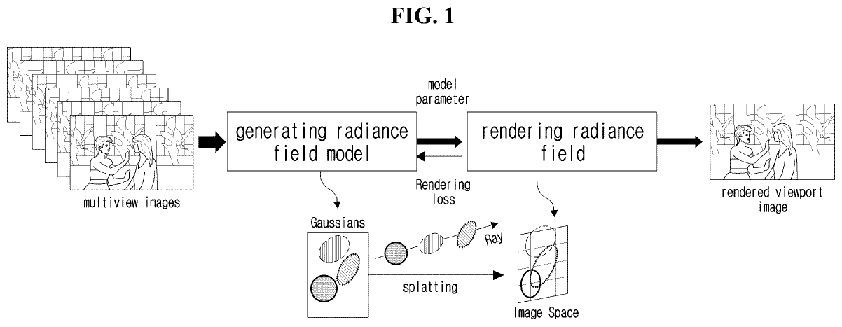

FIG. 1 illustrates method of representing a 3D space based on a radiance field and rendering a video.

As illustrated in the example in FIG. 1, information in a 3D space may be modeled through learning based on a neural network, and the 3D space may be rendered using model data.

Among 3D space representation methods, Gaussian splatting refers to a method of modeling pointers in a 3D space with a Gaussian distribution. A pointer modeled with a Gaussian distribution may be referred to as a GS (Gaussian Splat) (or Gaussian pointer).

Through the model parameters of Gaussian splats, the Gaussian splats in a 3D space may be projected onto an image plane, thereby rendering an image corresponding to an arbitrary viewpoint.

Meanwhile, the model parameters representing a Gaussian splat may comprise geometric information and attribute information. Geometric information may comprise at least one of position, rotation, or scale, and attribute information may comprise at least one of spherical harmonics, opacity, or color. Alternatively, at least one of rotation or scale may be defined as attribute information rather than geometric information.

The model parameters representing a Gaussian splat may be huge data represented as 32-bit floating point numbers.

Additionally, model data representing a Gaussian splat may further include a feature map for utilizing a neural network such as MLP.

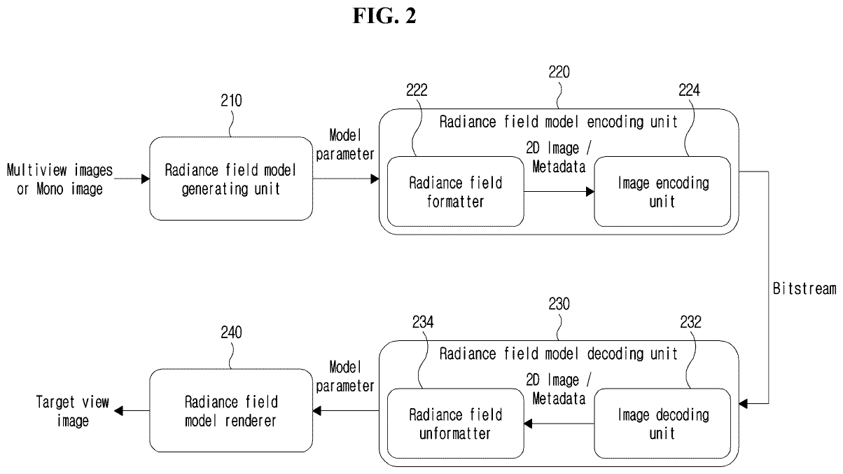

FIG. 2 is a block diagram illustrating an encoder and a decoder for providing a radiance field-based 3D service according to an embodiment of the present disclosure.

An encoder encodes data for a radiance field model. For example, a server transmitting a bitstream to a terminal may correspond to the encoder.

A decoder decodes data for a radiance field model. For example, a terminal receiving a bitstream from a server may correspond to the decoder.

The encoder may comprise a radiance field model generating unit 210 and a radiance field model encoding unit 220.

The radiance field model generating unit 210 generates a radiance field model from an input image.

If the radiance field model is related to Gaussian splatting, the model parameters defining the radiance field model may comprise geometric information and attribute information of Gaussian splats. The radiance field model encoding unit 220 encodes model parameters constituting the radiance field model. Meanwhile, the radiance field model encoding unit 220 may include a radiance field formatter 222 and an image encoding unit 224.

The radiance field formatter 222 converts the model parameters into a format suitable for encoding by the image encoding unit 224. For example, if the image encoding unit 224 operates based on a codec that encodes 2D images (e.g., HEVC, VVC, or AV1), the radiance field formatter 220 may convert the model parameters into a 2D image.

The image encoding unit 224 may encode an image (e.g., a 2D image) output from the radiance field formatter 222. The data (i.e., bitstream) output from the radiance field model encoding unit 220 may be transmitted to a decoder via a network.

The decoder may comprise a radiance field model decoding unit 230 and a radiance field renderer 240.

The radiance field model decoding unit 230 decodes encoded model parameters. Meanwhile, the radiance field model decoding unit 230 may comprise an image decoding unit 232 and a radiance field unformatter 234.

The image decoding unit 234 decodes an image. The decoded image may comprise data related to the radiance field model, i.e., model parameters.

The radiance field unformatter 234 reconstructs the radiance field model based on the decoded image. If the radiance field model is based on Gaussian splatting, the radiance field unformatter 234 may reconstruct Gaussian splats in 3D space from the decoded image. That is, the radiance field model may be reconstructed by obtaining model parameters of each Gaussian splat in 3D space from the decoded image.

The radiance field renderer 240 may render a 2D image of a target viewpoint based on the reconstructed radiance field model.

As in the example described above, the model parameters representing the radiance field model are converted into a form suitable for encoding/decoding. For example, if a codec for 2D video compression is used during encoding/decoding, a 2D image is generated based on the model parameters, and the generated 2D image is encoded/decoded.

Meanwhile, if the radiance field model involves Gaussian splatting, the model parameters of Gaussian splats may be converted into a 2D image.

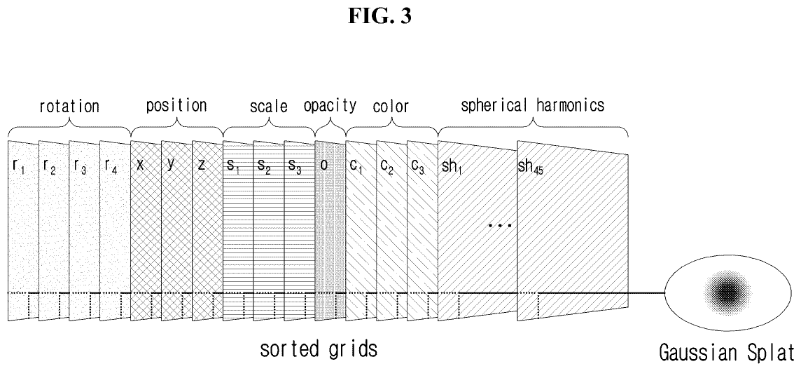

FIG. 3 illustrates an example of model parameters of Gaussian splat being converted into 2D images.

Each model parameter may be represented by at least one 2D image. Specifically, a number of 2D images equal to the number of sub-parameters of the model parameters may be generated.

For example, in the example illustrated in FIG. 3, rotation information is represented by four 2D images (r₁, r₂, r₃, r₄), position information is represented by three 2D images (x, y, z), and scale information is represented by three 2D images (s₁, s₂, s₃). Furthermore, opacity information is represented by one 2D image (o), color information is represented by three 2D images (c₁, c₂, c₃), and spherical harmonic function information is represented by 45 2D images (sh₁, sh₂, . . . sh₄s).

Alternatively, each sub-parameter may be defined as a patch, and the patches of the sub-parameters may be packed to generate a 2D image.

Information at the same coordinates within the 2D images may be for a single Gaussian splat. That is, by collecting information at the same coordinates within the 2D images, the model parameters for a single Gaussian splat may be reconstructed.

That is, the resolution (i.e., a number of pixels) of the 2D image may be equal to or greater than the number of Gaussian splats. For example, information at position (10, 10) within a 2D image may represent the model parameters of the 100-th Gaussian splat.

The model parameters of the Gaussian splats may be expressed as 2D images, and then the 2D images may be encoded/decoded. To improve compression performance, the spatial correlation between Gaussian splats may be increased by adjusting the arrangement order of the Gaussian splats.

Meanwhile, the radiance field formatter 222 may generate a 2D image by performing normalization on an original model parameter of high-bit during the quantization process. Through the normalization, the original model parameter with high-bit may be converted into a pixel value with low-bit (e.g., 12-bit or 10-bit) for video encoding. Here, the normalization may be non-linear normalization, and the non-linear normalization may be performed based on piece-wise linear scaling or a multi-order non-linear function.

The radiance field unformatter 234 may restore model parameters of a Gaussian splat from a decoded pixel value through denormalization.

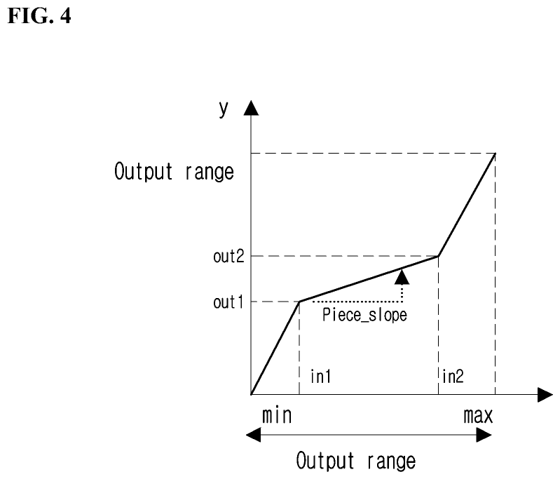

FIG. 4 illustrates an example of non-linear normalization based on piece-wise linear scaling.

In the example illustrated in FIG. 4, the x-axis represents a value of a model parameter, and the y-axis represents an output pixel value.

“min” represents the minimum value in the interval where the model parameters are distributed, and “max” represents the maximum value in the interval where the model parameters are distributed. The scaling ratio (i.e., slope) may vary for each piece. The scaling ratio may be determined by an input piece interval (e.g., an interval defined based on in1 and in2), an output piece interval (e.g., an interval defined based on out1 and out2), and the number of pieces.

Meanwhile, an input piece interval, an output interpolation interval, and the number of pieces may be determined through learning based on a neural network. Specifically, the above items may be determined based on the histogram distribution of the input data. For example, the slope ‘piece_slope’ may be determined in proportion to the density of the positional information of the Gaussian splats between in1 and in2. Accordingly, the denser the Gaussian splats, the greater the slope ‘piece_slope’, which may increase the bit-depth during the quantization process.

Non-linear normalization may be performed based on an n-th order non-linear function. For example, the n-th order non-linear function for non-linear normalization may be represented as shown in the following equation 1.

$$f ( x ) = {a}_{n} {x}^{n} + {a}_{n - 1} {x}^{n - 1} + … + {a}_{1} x + {a}_{0} \qquad [ Equation 1 ]$$

The coefficients of the nonlinear function (i.e., aₙ, aₙ₋₁, . . . , a₀) may be determined through learning based on a neural network.

To enable the radiance field unformatter 234 to reconstruct model parameters from pixel values, information regarding non-linear normalization may be encoded and signaled as metadata. The non-linear normalization information may comprise at least one of information defining input piece intervals, information defining output piece intervals, the number of piece intervals, or information regarding the coefficients of a non-linear function.

Meanwhile, non-linear normalization may be performed only on model parameters of a predefined type. For example, non-linear normalization may be performed only on opacity information.

Alternatively, whether to perform non-linear normalization may be adaptively determined for each model parameter. In this case, information indicating whether non-linear normalization has been performed for a model parameter may be encoded and signaled for each model parameter.

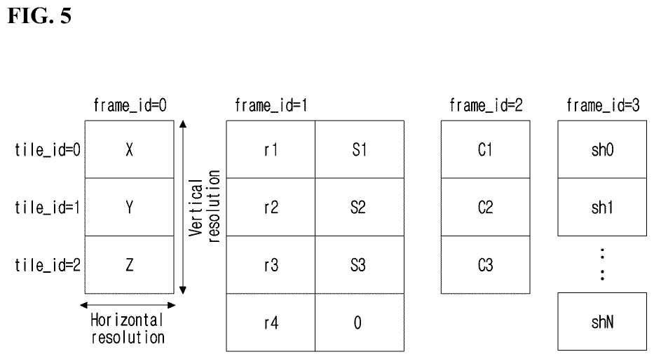

FIG. 5 illustrates an example of a video frame structure generated by converting a model parameter.

The model parameters of Gaussian splats may be packed into a plurality of 2D images.

For example, in the example illustrated in FIG. 5, position information is packed into a first video frame (frame_id=0), rotation information (r1, r2, r3, r4), scale information (S1, S2, S3), and opacity (O) are packed into a second video frame (frame_id=1). Furthermore, color information (C1, C2, C3) is packed into a third video frame (frame_id=2), and spherical harmonic functions (sh0, sh1, . . . shN) are packed into a fourth video frame (frame_id=3).

The model parameters of Gaussian splats may be packed into more video frames than shown in FIG. 5, or they may be packed into fewer video frames than shown in FIG. 5.

Each of the plurality of video frames may constitute an independent video sequence. For example, in the example shown in FIG. 5, four video frames with different identifiers may represent video that is independently encoded/decoded.

Alternatively, each of the plurality of video frames may be defined as a layer of a multilayer video. In this case, the video frame identifier (i.e., frame_id) may indicate the identifier of the layer to which the video frame belongs.

Alternatively, the video frame identifier (i.e., frame_id) may indicate the identifier of an atlas. That is, when defining an image in which an attribute is packed as an atlas, the video frame identifier may indicate the identifier of the atlas in which the attribute is packed.

Meanwhile, the sub-parameters of each model parameter or model parameters may be packed into different tiles. For example, in the example illustrated in FIG. 5, each of the sub-information of the position information (i.e., X-axis position information, Y-axis position information, and Z-axis position information) is exemplified as being packed into a different tile. In addition, in the example illustrated in FIG. 5, each of the sub-information of the rotation information (r1, r2, r3, r4), the sub-information of the scale information (S1, S2, S3), and the opacity information (O) is exemplified as being packed into a different tile.

Meanwhile, model parameters packed into a single video frame may be encoded using the same encoding parameters (e.g., quantization coefficients).

If a model parameter comprises numerous sub-parameters or represents supplementary information, such as spherical harmonic functions, it may be encoded in a reduced size. In this case, the decoder may restore the decoded data to its original size.

Alternatively, the scale ratio may be set differently for each order of the spherical harmonic functions. For example, the 0-th order spherical harmonic function may be embedded into a 2D image while maintaining the size of the original packing region, while higher-order (e.g., 1st to N-th order) spherical harmonic functions may be embedded into the 2D image with a size smaller than the original packing region. Accordingly, a size of tile occupied by the 0-th order spherical harmonic function within the 2D image may be larger than a size of tile occupied by higher-order spherical harmonic functions.

To reconstruct model parameters of Gaussian splats in a decoder, video frame information may be encoded and signaled as metadata. The video frame information may include at least one of the number of video frames, video frame identification information, video frame sizes (i.e., horizontal resolution and vertical resolution), video frame scale ratio, or video frame model parameter type information.

Furthermore, to reconstruct attribute information of Gaussian splats in a decoder, tile information may be encoded and signaled as metadata. The tile information may include at least one of the number of tiles, tile positions, tile identification information, tile sizes (i.e., horizontal resolution and vertical resolution), tile scale ratio, or model parameter type information.

The model parameter type information is to identify a type of a model parameter packed in a video frame or tile. As described above, the model parameter type information may be encoded and signaled in units of video frames or tiles. Table 1 shows an example of how the type of a model parameter is determined by the syntax vuh_unit_type.

TABLE 1

| vuh_unit_type | Identifier | V3C unit type |
|---|---|---|
| 0 | V3C_VPS | V3C parameter set |
| 1 | V3C_AD | Atlas data |
| 2 | V3C_OVD | Occupancy video data |
| 3 | V3C_GVD | Geometry video data |
| 4 | V3C_AVD | Attribute video data |
| 5 | V3C_PVD | Packed Video Data |
| 6 | V3C_CAD | Common Atlas Data |
| 7 | V3C_BMD | Basemesh data |
| 8 | V3C_GSC_VIDEO_XYZ | Position XYZ |
| 9 | V3C_GSC_VIDEO_OPA | Opacity (1 components) |
| 10 | V3C_GSC_VIDEO_SCA | Scale XYZ |
| 11 | V3C_GSC_VIDEO_RT0 | Rotation XYZ |
| 12 | V3C_GSC_VIDEO_RT1 | Rotation W |
| 13 | V3C_GSC_VIDEO_RGB | DC values (RGB) |
| 14 | V3C_GSC_VIDEO_SH | All spherical harmonics (15 frames) |
| 15 | V3C_GSC_VIDEO_SH0 | Spherical harmonic order 0 |
| 16 | V3C_GSC_VIDEO_SH1 | Spherical harmonic order 1 |
| 17 | V3C_GSC_VIDEO_SH2 | Spherical harmonic order 2 |
| 18 | V3C_GSC_VIDEO_SH3 | Spherical harmonic order 3 |
| 19 | V3C_GSC_VIDEO_SH4 | Spherical harmonic order 4 |
| 20 | V3C_GSC_VIDEO_SH5 | Spherical harmonic order 5 |
| 21 | V3C_GSC_VIDEO_SH6 | Spherical harmonic order 6 |
| 22 | V3C_GSC_VIDEO_SH7 | Spherical harmonic order 7 |
| 23 | V3C_GSC_VIDEO_SH8 | Spherical harmonic order 8 |
| 24 | V3C_GSC_VIDEO_SH9 | Spherical harmonic order 9 |
| 25 | V3C_GSC_VIDEO_SH10 | Spherical harmonic order 10 |
| 26 | V3C_GSC_VIDEO_SH11 | Spherical harmonic order 11 |
| 27 | V3C_GSC_VIDEO_SH12 | Spherical harmonic order 12 |
| 28 | V3C_GSC_VIDEO_SH13 | Spherical harmonic order 13 |
| 29 | V3C_GSC_VIDEO_SH14 | Spherical harmonic order 14 |
| 30-31 | V3C_RSVD | Reserved |

In Table 1, from 8 to 29 of vuh_unit_type correspond to model parameters of Gaussian splats.

For example, V3C_VIDEO_XYZ represents position information, V3C_VIDEO_OPA represents opacity information, and V3C_VIDEO_SCA represents scale information. V3C_VIDEO_RT0 represents first rotation information (r1, r2, r3), V3C_VIDEO_RT1 represents second rotation information (r4), and V3C_VIDEO_RGB represents color information. V3C_VIDEO_SH indicates that all orders of spherical harmonic functions are packed into a single video frame. In this case, N-th order spherical harmonic functions may be packed across temporally consecutive frames. V3C_VIDEO_SHN indicates that N-th order spherical harmonic functions are packed into a video frame.

Alternatively, if attribute information is packed into a video frame or tile, a syntax indicating one of the model parameters belonging to the attribute information may be encoded and signaled. Table 2 shows an example in which the type of the model parameter categorized into the attribute information is determined by the syntax attribute_type_id.

TABLE 2

| attribute_ type_id | Identifier | Attribute type |
|---|---|---|
| 0 | ATTR_Rotation | GS Rotation |
| 1 | ATTR_Opacity | GS Opacity |
| 2 | ATTR_Scaling | GS Scaling |
| 3 | ATTR_SH | GS Spherical Harmonics |

When a video frame is composed of a plurality of channels, such as YUV or RGB, different model parameters or sub-parameters may be packed for each channel.

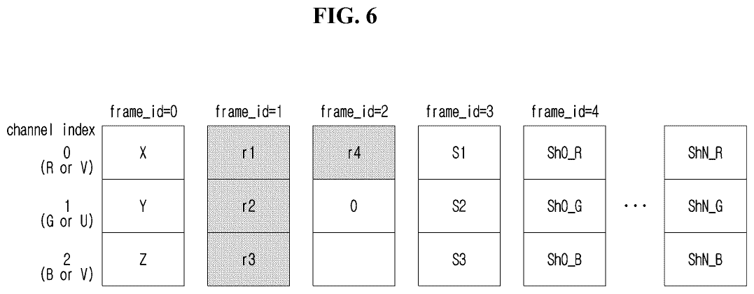

FIG. 6 illustrates an example in which model parameters or sub-parameters of Gaussian splats are packed into different channels.

In the example illustrated in FIG. 6, each of the sub-information pieces of position information (i.e., X-axis position information, Y-axis position information, and Z-axis position information) is packed into a different channel within the first video frame (frame_id=1).

Furthermore, three sub-information pieces of rotation information (r1, r2, r3) are packed into different channels within the second video frame (frame_id=1), and the remaining sub-information pieces of rotation information (r4) and opacity information are packed into different channels within the third video frame (frame_id=2).

Additionally, the three sub-information pieces (S1, S2, S3) of the scale information were exemplified as being packed into different channels of the fourth video frame (frame_id=3).

Furthermore, the N-th order spherical harmonic function was exemplified as being packed into a single video frame, and each color component (ShN_R, ShN_G, ShN_B) of the N-th order spherical harmonic function was packed into different channels within the video frame.

Meanwhile, information identifying the sub-information contained in the video frame may be encoded and signaled. This information may be identification information identifying one of the a plurality of sub-information pieces constituting a model parameter.

To reconstruct the model parameters of the Gaussian splat in the decoder, model parameter type information may be encoded and signaled. This information may be encoded for each channel within the video frame.

Meanwhile, the geometric information of the Gaussian splat must be represented using high-depth bits. Accordingly, the geometric information of a Gaussian splat may be encoded by dividing it into multiple video frames. For example, if the position information of a Gaussian splat is expressed in 16 bits, the upper bits (e.g., data from bits 15 to 8) of the position information may be packed into a first video frame (e.g., a video frame with frame_id 0), and the lower bits (e.g., data from bits 7 to 0) may be packed into a second video frame (e.g., a video frame with frame_id 1).

To support real-time rendering, the rendering quality of 3D space may be adjusted based on network capacity and/or user device performance. The adjustment of 3D rendering quality may be referring to as LOD (Level of Detail).

To support LOD, model parameters may be divided into multiple levels, and each level may be configured to be packed into a different unit. Here, a unit may represent a tile, slice, sub-image, or image, which may be independently encoded and decoded from other units.

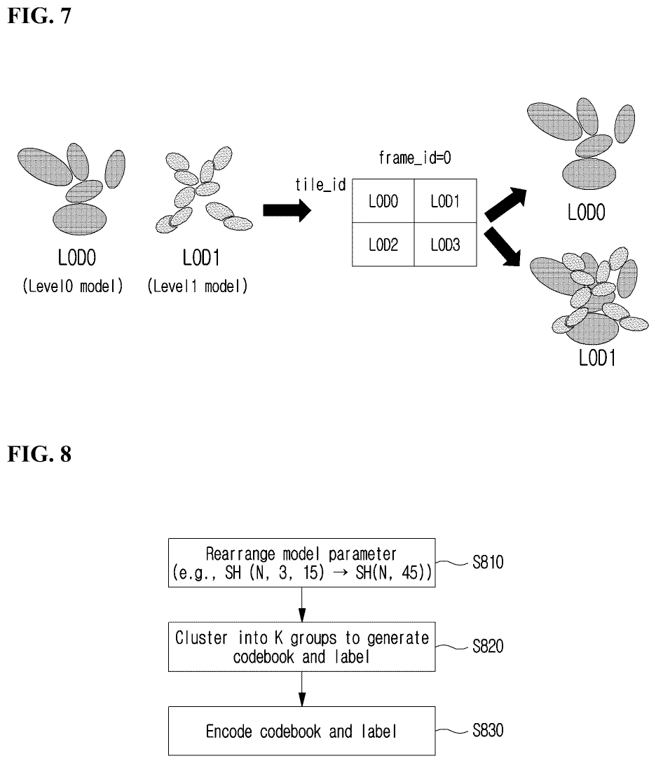

FIG. 7 illustrates an example where model parameters at different levels are packed into different tiles.

When modeling 3D space using Gaussian splatting, the quality of spatial representation may be controlled by varying the density of Gaussian splats. Specifically, higher density of Gaussian splats leads to higher-quality rendering results, but also increases the amount of data to be encoded/decoded.

Meanwhile, as shown in the example shown in FIG. 7, multiple radiance field models at different levels may be generated to adaptively determine rendering quality. Specifically, when rendering is performed solely using the low-density model LOD0, the density of Gaussian splats decreases, resulting in lower rendering quality. Conversely, when rendering is performed using both the low-density model LOD0 and the high-density model LOD1, the density of Gaussian splats increases compared to using the low-density model LOD0 alone, resulting in higher rendering quality. Here, LOD(N) represents a model with level N.

Meanwhile, each model may be generated by subsampling Gaussian splats. For example, if LOD0 includes model parameters for Gaussian splats selected through subsampling at a predetermined rate, LOD1 may be generated by subsampling the remaining Gaussian splats, excluding those in LOD0, at the predetermined rate.

Alternatively, multiple models may be generated by limiting the range of scaling parameters during the modeling process.

That is, the LOD(N) model may include model parameters for Gaussian splats not included in the LOD0 to LOD(N−1) models.

Multiple models at different levels may be packed into different regions within a video frame. Here, a region represents a unit capable of independent encoding/decoding, and may represent a tile, slice, patch, block, or sub-image.

Alternatively, multiple models at different levels may be packed into different video frames.

The decoder may receive/decode at least one of multiple models, depending on the required rendering quality. For example, if low-quality rendering is sufficient, rendering may be performed by reconstructing only the model parameters packed in LOD0. However, if higher-quality rendering is required, rendering may be performed by reconstructing the model parameters packed in LOD0 and LOD1.

In other words, the number of models received/decoded may vary depending on the required rendering quality.

Meanwhile, rendering quality information may be encoded and signaled to enable the decoder to receive/decode models according to the required rendering quality. The rendering quality information may include at least one of the following: the number of models within a video frame (i.e., the number of levels), model identification information (i.e., level identification information), or information on a region within the video frame where a model is packed. Here, information on a region where a model is packed may include at least one of region location information or region size information.

Meanwhile, an encoding parameter (e.g., quantization level) may vary for each model. Accordingly, the encoding parameter may be explicitly encoded and signaled for each model.

The decoder may determine the rendering quality based on at least one of the user's selection, the transmission network environment, or the terminal's capacity. Once the rendering quality is determined, at least one model may be selected to reproduce an image corresponding to the determined rendering quality. For example, if the required rendering quality is low, the spatial video may be generated based on a single model (e.g., LOD0). Conversely, if the required rendering quality is high, the spatial video may be generated based on multiple models.

Adjusting the rendering quality may be implemented by differentiating at least one of the spatial resolution, temporal resolution, or quantization level. Furthermore, rendering quality may be set differently for each region within 3D space. The regions may be generated by dividing the 3D space. Alternatively, the regions may be divided into background and foreground regions, or may be divided into different objects. Alternatively, the regions may be divided into still and moving regions.

In this case, identification information that identifies the model for each region, background and foreground, object, or still and moving region may be encoded and signaled.

Furthermore, information related to a definition of the region may be encoded and signaled. Based on this information, it is determined how the regions are divided.

For a model parameter with a large amount of original data, vector quantization may be used to encode/decode the model parameter. For example, vector quantization may be used to encode/decode spherical harmonic functions. Meanwhile, the use of vector quantization can be differently set depending on the order of the spherical harmonic function. For example, the 0th-order spherical harmonic function, which has a high correlation between adjacent pixels, may be packed into a video frame without vector quantization.

On the other hand, for high-order (e.g., 1st, 2nd, or 3rd) spherical harmonic functions, which have a low correlation between adjacent pixels but a large amount of data, the pixel values obtained through vector quantization may be packed into a video frame.

FIG. 8 is a flowchart of a method for packing a higher-order spherical harmonic function into a video frame.

For convenience of explanation, it is assumed that a third-order spherical harmonic function is encoded/decoded.

For a third-order spherical harmonic function, there are 15 coefficients for each of the three channels (i.e., RGB). Thus, a total of 45 coefficients may present.

By aligning the 45 coefficients of N Gaussian splats, a 2D array of size (N, 45) may be generated S810.

For vector quantization, K-means clustering is performed on the 2D array of size (N, 45) to generate a codebook and N labels, expressed as a 2D array of size (K, 45) S820. Here, K-means clustering may be used to cluster N data into K clusters based on K center values and the distances between the data. Additionally, the codebook may map each of the K clusters to a code value. Consequently, generating the codebook may be equivalent to quantizing the values of the spherical harmonic function coefficients into code values.

A label indicates a code value within the codebook for representing each of the N Gaussian splats. Accordingly, the decoder may reconstruct the spherical harmonic function coefficients of the Gaussian splats based on the codebook and the labels.

To this end, the encoder may encode and signal the codebook and a label for each Gaussian splat S830.

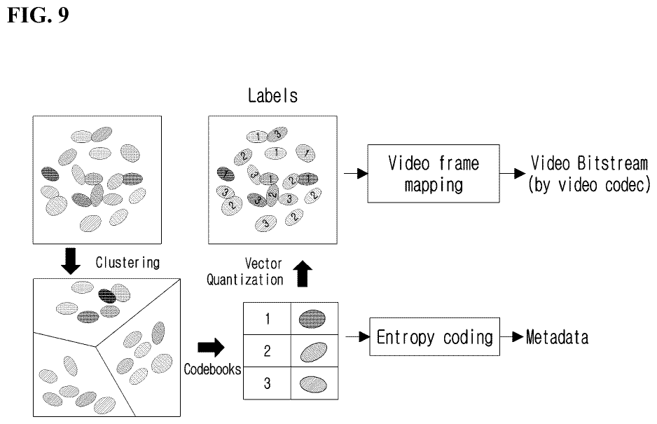

FIG. 9 illustrates an example of encoding the spherical harmonic function coefficients of a Gaussian splat based on a codebook and a label.

In FIG. 9, the spherical harmonic function coefficients of a Gaussian splat are exemplified as being classified into three clusters. As a result, a codebook is generated that assigns the three clusters and their corresponding code values, and a label indicating the code value of the codebook may be generated for the Gaussian splat.

The codebook and the label may be explicitly encoded and encoded.

Each of codebook and label may be converted into a two-dimensional array and encoded/decoded using a 2D video codec.

Alternatively, as in the example illustrated in FIG. 9, a codebook has a relatively small amount of data, thus it may be encoded using a simple compression method and transmitted as metadata. On the other hand, the labels may be encoded/decoded in the form of video frames.

According to the present disclosure, a method for encoding/decoding model parameters of a Gaussian splat into 2D images for 3D space representation may be provided.

According to the present disclosure, Gaussian splats may be efficiently compressed by packing model parameters of a Gaussian splat into a plurality of regions and encoding/decoding metadata for the same.

According to the present disclosure, Gaussian splats may be efficiently compressed by classifying model parameters of a Gaussian splat into multiple levels, packing data for each level into a plurality of regions, and encoding/decoding metadata for the same.

The effects that may be obtained from the present disclosure are not limited to the effects mentioned above, and other effects not mentioned herein may be clearly understood by those skilled in the art from the above description.

A name of syntax elements introduced in the above-described embodiments is only temporarily given to describe embodiments according to the present disclosure. Syntax elements may be referred to as names different from those proposed in the present disclosure.

A component described in illustrative embodiments of the present disclosure may be implemented by a hardware element. For example, the hardware element may include at least one of a digital signal processor (DSP), a processor, a controller, an application-specific integrated circuit (ASIC), a programmable logic element such as an FPGA, a GPU, other electronic device, or a combination thereof. At least some of functions or processes described in illustrative embodiments of the present disclosure may be implemented by software and the software may be recorded in a recording medium. A component, a function, and a process described in illustrative embodiments may be implemented by a combination of hardware and software.

A method according to an embodiment of the present disclosure may be implemented by a program which may be performed by a computer and the computer program may be recorded in a variety of recording media such as a magnetic storage medium, an optical reading medium, a digital storage medium, etc.

A variety of technologies described in the present disclosure may be implemented by a digital electronic circuit, computer hardware, firmware, software, or a combination thereof. The technologies may be implemented by a computer program product, that is, a computer program tangibly implemented on an information medium or a computer program processed by a computer program (for example, a machine-readable storage device (for example, a computer-readable medium) or a data processing device) or a data processing device or implemented by a signal propagated to operate a data processing device (for example, a programmable processor, a computer, or a plurality of computers).

Computer program(s) may be written in any form of a programming language including a compiled language or an interpreted language and may be distributed in any form including a stand-alone program or module, a component, a subroutine, or other unit suitable for use in a computing environment. A computer program may be performed by one computer or a plurality of computers which are located at one site or spread across multiple sites and are interconnected by a communication network.

An example of a processor suitable for executing a computer program includes a general-purpose and special-purpose microprocessor and one or more processors of a digital computer. In general, a processor receives an instruction and data in a read-only memory (ROM), a random-access memory (RAM), or both memories. A component of a computer may include at least one processor for executing an instruction and at least one memory device for storing an instruction and data. In addition, a computer may include one or more mass storage devices for storing data, for example, a magnetic disk, a magneto-optical disc, or an optical disc, or may be connected to the mass storage device to receive and/or transmit data. An example of an information medium suitable for implementing a computer program instruction and data includes a semiconductor memory device (for example, a magnetic medium such as a hard disk, a floppy disk, or a magnetic tape), an optical medium such as a compact disc read-only memory (CD-ROM), a digital video disc (DVD), etc., a magneto-optical medium such as a floptical disk, and a ROM, a RAM, a flash memory, an EPROM (Erasable Programmable ROM), an EEPROM (Electrically Erasable Programmable ROM) and other known computer readable medium. A processor and a memory may be complemented or integrated by a special-purpose logic circuit.

A processor may execute an operating system (OS) and one or more software applications executed in an OS. A processor device may also respond to software execution to access, store, manipulate, process and generate data. For simplicity, a processor device is described in the singular, but those skilled in the art may understand that a processor device may include a plurality of processing elements and/or various types of processing elements. For example, the processor device may include a plurality of processors or a processor and a controller. In addition, the processor device may configure a different processing structure like parallel processors. In addition, a computer readable medium means all media which may be accessed by a computer and may include both a computer storage medium and a transmission medium.

The present disclosure includes detailed description of various detailed implementation examples. However, it should be understood that the detailed content does not limit a scope of claims or an invention proposed in the present disclosure and describes features of a specific illustrative embodiment.

Features which are individually described in illustrative embodiments of the present disclosure may be implemented by a single illustrative embodiment. Conversely, a variety of features described regarding a single illustrative embodiment in the present disclosure may be implemented by a combination or a proper sub-combination of a plurality of illustrative embodiments. Further, in the present disclosure, the features may be operated by a specific combination and may be described as the combination is initially claimed, but in some cases, one or more features may be excluded from a claimed combination or a claimed combination may be changed in a form of a sub-combination or a modified sub-combination.

Likewise, although an operation is described in specific order in a drawing, it should not be understood that it is necessary to execute operations in specific turn or order or it is necessary to perform all operations in order to achieve a desired result. In a specific case, multitasking and parallel processing may be useful. In addition, it should not be understood that a variety of device components should be separated in illustrative embodiments of all embodiments and the above-described program component and device may be packaged into a single software product or multiple software products.

Illustrative embodiments disclosed herein are just illustrative and do not limit a scope of the present disclosure. Those skilled in the art may recognize that illustrative embodiments may be variously modified without departing from claims and a spirit and a scope of equivalents thereto.

Accordingly, the present disclosure includes all other replacements, modifications and changes belonging to the following claim.

What is claimed is:

1. A method of encoding a Gaussian splat for 3D space representation, the method comprising:
generating model parameters of Gaussian splats;
generating at least one video frame based on the model parameters; and
encoding the at least one video frame,
wherein type information indicating a type of a model parameter included in a video frame is encoded as a metadata.

2. The method of claim 1, wherein each model parameter is packed into a separate video frame, and
wherein the type information is encoded for each of video frame.

3. The method of claim 2, wherein a first video frame comprises a first model parameter, and
wherein each of sub-parameters of the first parameter is packed into a separate tile in the first video frame.

4. The method of claim 1, wherein information for identifying the sub-parameters comprised in the first video frame is encoded.

5. The method of claim 2, wherein a first frame comprises a first model parameter, and
wherein each of sub-parameters of the first model parameter is packed into a separate channel of the first video frame.

6. The method of claim 2, wherein high-bit data of a first model parameter is packed into a first video frame and low-bit data of the first model parameter is packed into a second video frame.

7. The method of claim 6, wherein the first model parameter represents position information of the Gaussian splats.

8. The method of claim 1, wherein a pixel value in the video frame is obtained by performing a non-linear transform on the model parameter.

9. The method of claim 8, wherein the non-linear transform is performed based on piece-wise linear scaling or a multiple order non-linear function.

10. The method of claim 9, wherein information on the piece-wise linear scaling or the multiple order non-linear function is encoded as a metadata, and
wherein the information comprises at least one of a number of piece intervals or coefficients of the non-linear function.

11. The method of claim 1, wherein a first model parameter is categorized into a plurality of levels, and
wherein each of the plurality of levels is packed into a separate region in the video frame or a separate video frame.

12. The method of claim 1, wherein a codebook is generated by assigning a code value to each of groups, the groups being obtained by categorizing data of a first model parameter,
wherein a first video frame is generated based on a label of attribute values constituting the first model parameter, and
wherein the label indicates a code value corresponding to an attribute value.

13. The method of claim 12, wherein the first mode parameter represents a high-order spherical harmonic function.

14. The method of claim 12, wherein the codebook is encoded separately with the first video frame as a metadata.

15. A method of decoding a Gaussian splat for 3D space representation, the method comprising:
decoding at least one video frame;
reconstructing model parameters of Gaussian splats from at least one decoded video frame; and
rendering an image of target viewpoint based on the model parameters of the Gaussian splats,
wherein type information indicating a type of a model parameter included in a video frame is decoded as a metadata.

16. A non-transitory computer readable medium storing instructions when executed cause the computer to carry out:
generate model parameters of Gaussian splats;
generate at least one video frame based on the model parameters; and
encode the at least one video frame,
wherein type information indicating a type of a model parameter included in a video frame is encoded as a metadata.
